(19) United States
(12) Patent Application Publication
(10) Pub. No.: US 2012/0323664 A1
(43) Pub. Date: Dec. 20, 2012

(54) INTEGRATED COUPON STORAGE, DISCOVERY, AND REDEMPTION SYSTEM

(75) Inventor: Ryan Rowat KLEMS, Oro Valley, AZ (US)

(73) Assignee: Apple Inc., Cupertino, CA (US)

(21) Appl. No.: 13/162,493

(22) Filed: Jun. 16, 2011

(51) Int. Cl. G06Q 30/00

(52) U.S. Cl. 705/14.26; 705/14.1; 705/14.38

(57) ABSTRACT

Disclosed herein are systems, methods, and non-transitory computer-readable storage media for managing and redeeming electronic coupons on a mobile device. The invention may also cause a mobile device to generate an alert when it is at or in the vicinity of a location such as a retail store where an electronic coupon held by the mobile device may be redeemed. An alert may also be caused when the mobile device is used in a sales transaction at the location. The electronic coupons may be redeemed in a number of ways including scanning an image displayed on the mobile device, communicating with a wireless network, or through an integrated near field payment system offered by the location.

### BACKGROUND

1. Technical Field

The present disclosure relates to storing information relating to a mobile device and more specifically to use a mobile device to redeem a coupon at a business establishment.

2. Introduction

Mobile devices have been adapted to a wide variety of applications, including computing, communication, and entertainment. Through recent improvements, mobile devices can now also determine their geographic location by either using a built-in global position system (GPS) antenna or extrapolating its location from the signals it receives through the network of fixed-location cellular antennas. Thus, applications running on a mobile device may offer features that are determinative upon the location of the device.

Mobile devices have also taken on the function of storing a great deal of user information. Users commonly store calendar events, contact information, favorite web pages, etc. In some cases, applications exist which store barcodes associated with value member cards for grocery stores, pharmacies, and other establishments. Further, near field communication technologies promise to enable phones to record payment information and security badge information as well. Last, and most relevant to the present technology, applications exist which allow users to clip coupons and store them on their mobile device.

However, despite the increasing amount of information being stored on mobile devices, the software devoted to storing and organizing this information fails to make sufficient use of other device functionalities to make the stored information more useful.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for storing coupons on a computing device and reminding a user of the computing device of their existence at opportune times.

A coupon wallet can reside on a server accessible to a mobile device, or on a mobile device. The coupon wallet is configured to receive and store coupons for potential redemption. In some embodiments, a user can enter a numerical value that uniquely identifies a coupon, or a user can scan an image of a coupon through an attached/integral bar code scanner or camera.

In some embodiments, the coupon can be validated by accessing a coupon server which stores coupon identifying information and additional details related to the coupon. The coupon server can further be configured to transmit this data to the coupon wallet for storage in association with the coupon.

As addressed above, the mobile device can store the coupon wallet locally, or access a server storing the coupon wallet. In either scenario, the mobile device is configurable to provide reminder alerts to a user of the mobile device to redeem the coupon. Such reminders can be associated with an expiration date of a coupon, whereby a notification can be presented to the user reminding them to redeem the coupon before it expires.

The reminders can also be associated with a geographic proximity to a location at which the coupon might be redeemed. In such embodiments, the mobile device can be informed of locations where the coupon can be redeemed through communication with the coupon wallet, which can download such information from the coupon server. In some embodiments, the coupon server can also include the address or geographic coordinates of such locations. However, in a more likely embodiment, the mobile device can perform this task by requesting such information from a geolocation database. The mobile device can use this information to establish a geo-fence around selected locations wherein the coupon can be redeemed.

In some embodiments, the geographic proximity can also be determined by an identifying signal broadcast by a business. For example, the business can provide a Wi-Fi network with a recognized network name.

In some embodiments, the mobile device can communicate with a business device to learn of products a user is about to purchase. If a product name matches a product name related to a coupon in the coupon wallet, the user can be notified of a coupon to redeem.

The coupon can be redeemed by presenting the mobile device to a store clerk to enter the barcode into the business device, or in some embodiments wherein the mobile device is also a payment device using near-field communication technology, the coupon can be automatically presented for redemption.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary general-purpose computing device;

FIG. 2 illustrates an exemplary mobile computing environment;

FIG. 3 illustrates a flow chart of an exemplary method of storing, discovering, and redeeming a coupon;

FIG. 4 illustrates an exemplary embodiment of a paper coupon being entered into the user's coupon wallet;

FIG. 5 illustrates an exemplary coupon wallet graphical interface;

FIG. 6 illustrates an exemplary coupon reminder on a mobile device; and

FIG. 7 illustrates an exemplary coupon stored in the user's coupon wallet.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

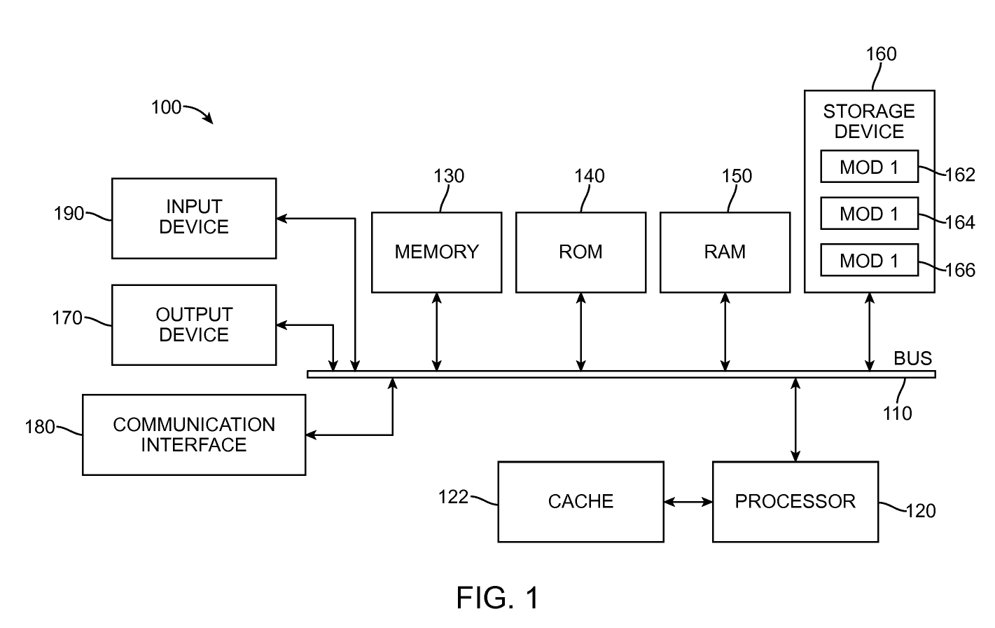

A brief introductory description of a basic general purpose system or computing device in FIG. 1, which can be employed to practice the concepts, is disclosed herein. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

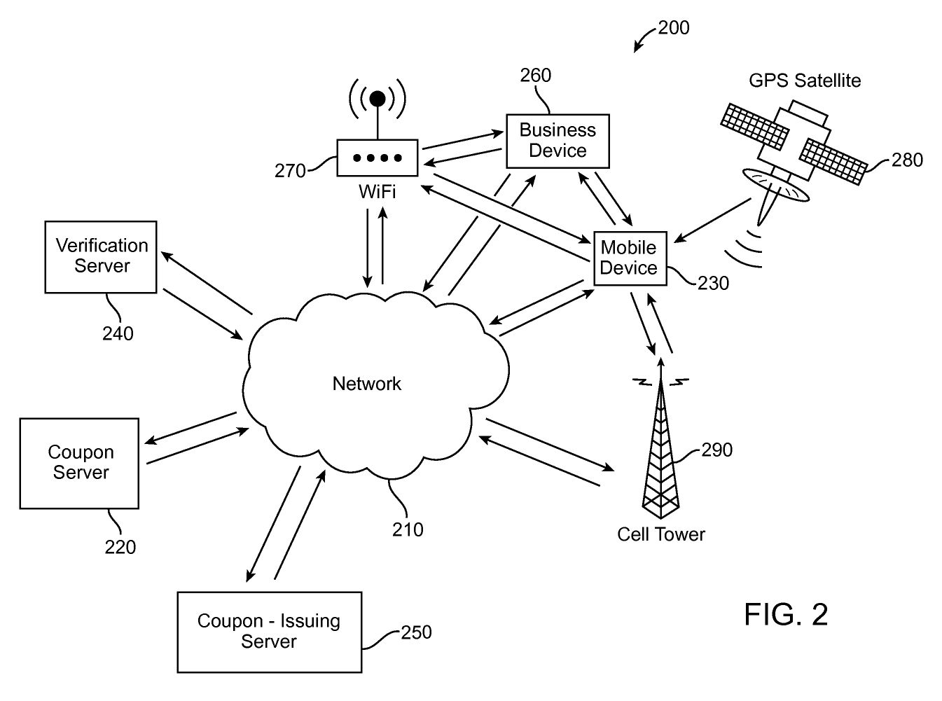

Having disclosed some components of a computing system, the disclosure now turns to FIG. 2, which illustrates a mobile computing environment 200. A communication network 210 connects the devices and applications hosted in the computing environment 200. In computing environment 200, multiple devices can communicate with and send commands to each other. For example, a mobile device 230 or business device 260, can be configured to communicate with each other or any number of servers such as a coupon server 220, verification server 240 and coupon-issuing server 250 through the communication network 210. A mobile device 230 can also be configured to communicate with a business device 260 directly through use of, for example, a near field communication system or blue tooth technology. A mobile device 230 and business device 260 can communicate through the use of a local area network by being connected to, for example, a local Wi-Fi router 270.

The mobile device 230 can be configured to store coupons in a coupon wallet, or to communicate with one or more servers which store the coupons in the coupon wallet. The coupon wallet can be an application, or part of an application, for collecting coupons that are redeemable by the mobile device user. In some embodiments, the mobile device 230 can be configured to provide reminders or alerts that are helpful in reminding a user to redeem a coupon.

These mobile devices are preferably smart phones such as an Apple iPhone® or post-personal computer device such as a tablet computing device but can also be other types of communication devices such as a cell phone, desktop or laptop computer. Each of the mobile devices 230 included in the computing environment 200 can include a network interface configured to establish a connection to the communication network 210. For example, mobile device 230 can establish a cellular (e.g., GSM, EDGE, 3G, or 4G) network connection that provides data access to the communication network 210. Such a connection may be facilitated by one or more cellular towers 290 located within the range of the mobile device 230 and connected to the network 210. Further, mobile device 230 can establish an IEEE 802.11 (i.e., WiFi or WLAN) network connection to the communication network 210. Such a connection may be facilitated by one or more wireless network routers 270 located within the range of the mobile device 230 and connected to the network 210. Also, the mobile devices 230 or an additional device may connect to the network 210 through the IEEE 802.16 (i.e., wireless broadband or WiBB) standard. Again, the device 230 may employ the assistance of a cell tower 290 or wireless router 270 to connect to the communication network 210.

Additionally, each of the mobile devices 230 can include an input interface, through which one or more inputs can be received. For example, the input interface can include one or more of a keyboard, a mouse, as joystick, a trackball, a touch pad, a keypad, a touch screen, a scroll wheel, general and special purpose buttons, a stylus, a video camera, and a microphone. Each of the mobile devices 230 can also include an output interface through which output can be presented, including one or more displays, one or more speakers, and a haptic interface. Further, a location interface, such as a Global Positioning System (GPS) processor, also can be included in one or more of the mobile devices 230 to receive and process signals sent from GPS satellites 280 for obtaining location information, e.g., an indication of current location. In some implementations, general or special purpose processors included in one or more of the mobile devices 230 can be configured to perform location estimation, such as through base station triangulation or through recognizing stationary geographic objects through a video interface. The mobile devices 230 can also include Bluetooth or near-field communication technology.

While many of the embodiments discussed herein reference the coupon wallet as residing on the mobile device 230, it should be appreciated that in some embodiments, the coupon wallet can be mirrored, or even primarily resident on other devices such as personal computers connected to the network 210, or servers, such as the coupon server 220.

The coupon server 220 can be configured to host and run a coupon catalog service. In such embodiments, the coupon server can validate coupons, and store meta-data related to the coupon for access and/or download by the coupon wallet. Such data can include information identifying the product or business for which the coupon can be redeemed, a coupon number or identifier such as a universal product code (UPC) associated with the coupon, specific information about the terms of the coupon such as the discount offered, the expiration date, or requirements for the offer to be redeemable, etc.

In addition to information identifying the coupon and its terms, the coupon server can also include information about the business the coupon is redeemable at, such as the location(s) of the business as well as information about the type of business. For example, if the coupon is for a free soft drink at a common fast food chain, the coupon server may also include the addresses of all locations of the fast food chain participating in the coupon offer. The coupon server can also include additional information about the business such as that the fast food chain is a restaurant, or more specifically a fast food restaurant specializing in hamburgers and fries that serves breakfast, lunch, and dinner and is open 7 days a week from 6 am-10 pm. The coupon server can even include a list of competitors and competing offers.

In some embodiments, the coupon server is not needed, and thus not present. It will be appreciated by those of ordinary skill in the art that many of the above mentioned functions of the coupon-issuing server 250 can be achieved using other commercial services in combination with other components of system 200. For example, coupon identifying information can alternately or redundantly present on the verification server 240, or coupon-issuing server 250. The business information can be alternatively downloaded from other commercial databases such as business directory services (e.g., yellow pages), and geographic information systems databases/geodatabases.

Also illustrated in FIG. 2 is coupon-issuing server 250. Coupon-issuing server 250 can be a server associated with any physical or Internet based business that issues coupons. In some embodiments, a coupon wallet can be configured to subscribe to a business for the purpose of receiving coupons from the business. For example, a user can register to enter a coupon service such as GROUPON® which offers users coupons on a regular basis or a rewards card program associated with a specific store. In this type of scenario, the user's coupon wallet can be updated to include information of the user's enrollment in these programs and the coupon server 220 can be configured to receive coupons into the user's coupon wallet from the appropriate coupon-issuing server 250 as the coupons become available to the user's account in the coupon service. This can be accomplished, for example, by configuring the coupon application on the coupon server 220 to periodically access the coupon-issuing server 250 of the coupon services using the information stored in the user's coupon wallet. For example, a grocery store offering a rewards card program may update their offered deals every day. The coupon server 220 can be configured such that every day the coupon server 220 will communicate with the coupon-issuing server 250 associated with the rewards card program and access the user's account using the rewards card number stored in the user's coupon wallet. Any information associated with a coupon not already entered in the user's coupon wallet can be transmitted from the coupon-issuing server 250 to the coupon server 220 over the communication network 210 and stored in the user's coupon wallet. Alternatively, the coupon service can be preconfigured to be in contact with the user's coupon wallet and send coupon information as it becomes available.

Also illustrated in FIG. 2 is verification server 240, which can be used to verify that a coupon is authentic. In some embodiments, verification server 240 can also verify that the coupon has not yet been redeemed. The verification server 240 can include a database of coupon information such as the name of the business offering the coupon, the expiration date of the coupon, the details of the offer, and any identifying coupon number or UPC code, etc. In some embodiments, the verification server can also include a log of users (by user account), or devices that have previously redeemed the coupon and thereby thwart abuses by unauthorized, repeated redemptions.

The computing environment 200 can also include one or more business devices 260. A business device can be any computing device used by a business to manage purchases. This may include a computerized cash register, laptop or desktop computer, as well as handheld computing devices. In some embodiments, the business devices can be in communication with the mobile device 230, wherein the coupon wallet can learn of potential purchases and alert the user of the mobile device 230 or available coupons pertaining to those potential purchases.

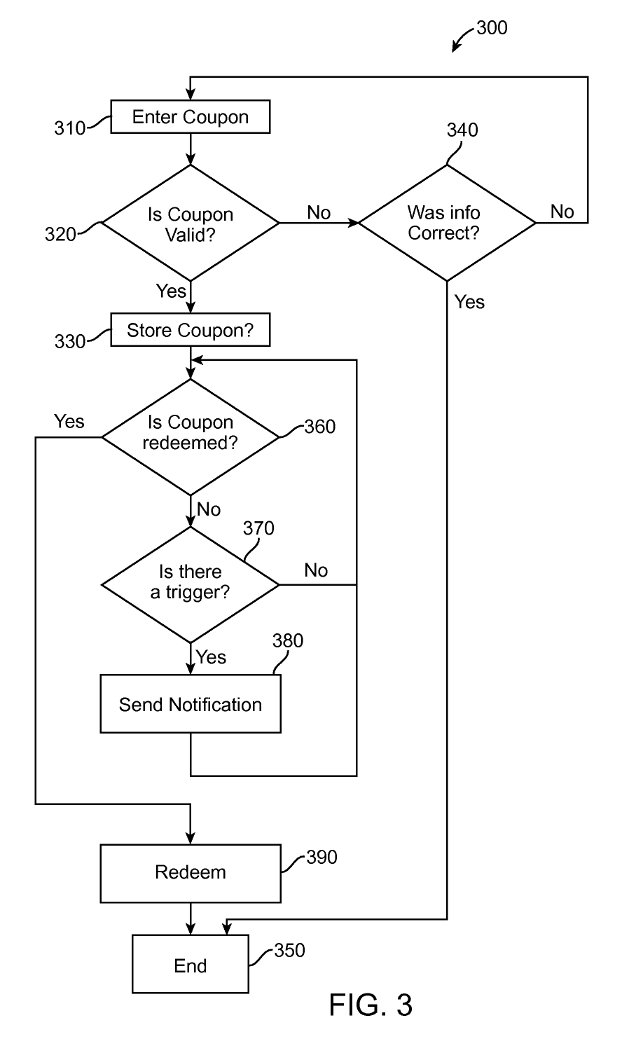

FIG. 3 illustrates a flow chart of an exemplary method 300 of storing, discovering, and redeeming a coupon. As shown, a user may enter coupons into a coupon wallet 310. The user's coupon wallet can store the user's coupons as well as any account information useful in providing coupon related services. In some embodiments, the coupon wallet can also be linked to payment methods such as an online payment service, credit or checking account. In this way, the user's coupon wallet can store and redeem coupons as well as directly make payments when desired.

Coupons can be entered 310 into the coupon wallet from multiple sources and in multiple formats. In some aspects, coupons can be offered in a traditional paper format as well as in electronic format. For example, the user may receive a traditional paper coupon through a number of sources such as a coupon mailer, an insert in a newspaper or magazine, or with a receipt upon purchase of a different item. This type of paper coupon can be entered into the coupon wallet manually by a user by entering the details of the coupon, such as an identification or offer number, if available, which identifies the coupon. Some coupons may include a bar code or similar scannable technology and thus the user can enter the coupon by, for example, scanning the bar code or taking a picture of the bar code. In some embodiments, a user can search for an available coupon on the coupon server 220.

Coupons may also be received in electronic format through a number of sources such as e-mail, electronic advertisements, location aware services, downloading from websites, coupon applications and so on. Electronic coupons may be entered manually, as described above, or, in some instances, automatically entered. For example, the user may receive a push notification on a mobile device offering the user a coupon. The push notification may have been received for a number of reasons, such as the user entered a geo-fence perimeter or the user is enrolled in a coupon application service which sends coupons to users as they become available. The system may be configured so that upon a user selecting to accept the coupon, the coupon is entered into the user's coupon wallet. Alternatively, the user may not even need to be notified for the coupon to be entered, the coupon may automatically be entered into the user's coupon wallet upon the coupon being offered to the user. For example, if the user is enrolled in a coupon service, or value card system through a specific store, the system can be configured to communicate with these services to automatically enter all coupons offered to the user. The service may also be configured so that coupons are automatically entered into the coupon wallet upon receiving a selection input on a mobile, or other online advertisement. Coupons may also be offered via email and entered into the coupon wallet by active selection by the user or automatically.

Once a coupon is entered 310 into the user's coupon wallet, it may be advantageous to have the coupon initially verified 320 for validity and authenticity. For example, the system can be configured to communicate with a verification server to ensure that the deal is being offered and the coupon has not yet been redeemed. The coupon identification number or offer number which was manually entered or scanned may be used to identify the coupon when communicating with the verification server 240. Upon receiving confirmation that the coupon is valid, the coupon can be stored 330 in the user's coupon wallet.

The verification can be performed by a simple comparison of numeric strings that uniquely identify a coupon to the verification server 240. However, in some embodiments, other metadata regarding the coupon such as data describing offer information can be compared if a numeric identifier is not available.

In some embodiments, it can be desirable to restrict a user from redeeming or storing coupons for which the user has already redeemed an acceptable number of times. In such embodiments, the verification server can maintain a log of user accounts, or device identifiers that have already redeemed the coupon being verified.

If it is determined that the coupon is already redeemed or not authentic, the user can be notified of the status of the entered coupon and the coupon may not be stored in the user's coupon wallet. In certain situations, the coupon may not be able to be verified. For example, the coupon offering business may not have an authentication server or no information has been entered into a verification server. In this situation, the user can be notified that the coupon could not be verified and the user can be given the option to store the coupon unverified. Alternatively, the coupon may not have been able to be verified because the information was entered incorrectly by the user and so it could not be found. This may be the case when the user is manually entering coupon information. To take into account this possibility, the user can also be prompted to confirm 340 the entered information and allowed to edit the entered 310 coupon information. If the unverified coupon information was entered correctly then the coupon information will not be stored and the method ends 350. Once stored, the coupon can be redeemed 360 by the user at any time.

A coupon can be redeemed by a user presenting the coupon displayed on a mobile device for scanning into a payment device, by a clerk keying in a coupon code, or automatically through communication between the mobile device and the payment device.

One common problem users have with redeeming coupons is that they forget to use the coupon and so never redeem the offered deal or the coupon eventually expires. To alleviate this problem, the current system can send the user reminder notifications in certain desirable instances until the coupon is redeemed. Instances which may trigger 370 a notification being sent to the user can include the user being in close proximity to a location at which a coupon can be redeemed, the user is viewing or trying to purchase an item for which the user has a coupon, and the coupon is nearing its expiration date, etc. The method may continually check for notification triggers 370 and send 380 a notification to the user when one has been triggered.

In some embodiments, the system can send 380 the user a notification that the user is in close proximity to a location at which a coupon can be redeemed. For example, a user with a coupon which can be redeemed at a chain sub-sandwich shop can be sent a notification reminding the user of the coupon when the user is near any of the chain sub-sandwich locations. Alternatively, a user with a coupon for a particular item such as brand name tortilla chips can be sent a reminder notification when the user is in close proximity to any store which sells brand name tortilla chips. The user can then, for example, be notified when he/she is in close proximity to a grocery store, convenience store, or gas station which sells the brand name tortilla chips. The proximity at which the user must be in to receive the notification can be a set distance or variable and in some embodiments is adjustable by the user. The notification sent to the user can be any known type of notification such as a push notification, text message or e-mail.

To implement proximity notifications, a geo-fence can be used. A geo-fence is a virtual perimeter for a real world geographic area. The perimeter can be around a set location such as a building or store. For example, the system can be configured so that anytime the user's location is determined to be within the set virtual perimeter set around any location in which a coupon can be redeemed, the user can be sent a notification. The user's location can be determined by the location of a mobile device that is location aware, such as a smartphone, for example. The location of the businesses can be determined by accessing a geo-location database, or the locations of businesses can be stored in the user's coupon wallet.

In some embodiments, the user can be sent a notification when the user is shopping for an item for which the user has a coupon in their coupon wallet. This may be done in numerous ways. For example, a user shopping at a business can enter the product information into their mobile device while shopping. The user information may be entered, for example, such as by typing in the product description or the product code number, taking a picture of the bar code or scanning the bar code or even taking a picture of the product, etc. The entered data can be checked against contents of the user's coupon wallet. If the user has any coupons which can be redeemed for the entered items, the user can be notified that there is an applicable coupon in the user's virtual wallet.

Alternatively, the user can be shopping online and sent notifications when the user has an available coupon. This can occur at any number of points such as when the user is viewing an item, after the user has added the item to their shopping cart, or just prior to payment. In such embodiments, a coupon application which includes the coupon wallet on the mobile device (or other computing device) can be configured to monitor a web browser for certain products. Alternatively, a webpage or web browser can include code to call to a coupon wallet whenever a shopping cart screen is loaded in the browser window.

Notifications can also be sent when a user is shopping for a similar item to one for which the user has a coupon. The user's coupon wallet may store information about the type of item as well as competing products and businesses. When a user enters product information, the information can be checked against the coupon information stored in the user's coupon wallet to determine if the user has a matching coupon or if the product is a competitor of a business for which the user has a coupon. For example, a user with a coupon for the brand name tortilla chips might get a notification upon entering the product information for a competing tortilla chip that there is a coupon for the comparable item offered by the brand name tortilla chips. Similarly, a user might get a notification when shopping for an item which can be purchased at another store for which the user has a coupon. For example, a user viewing a book on an online book store might get a notification reminding the user that they have a coupon to a competing book store which can be used to purchase the same item.

In some embodiments, the product information can be entered when a user is ready to pay for selected items. For example, the mobile device can include near field communication technology or blue tooth technology or Wi-Fi and can communicate with a similarly capable business device. As the user's items are scanned by the business device, all the items can be transmitted to the business device to the wallet. If the user has an available coupon, the user can be notified, or the coupon information can be transmitted back to the business device. Additionally, if the user's coupon wallet is connected to a payment method such as an electronic payment account or checking account, the appropriate coupons may be automatically applied to the user's purchases and payment may be sent using the mobile device.

In some embodiments, users may be sent reminder notifications based on time. The user's coupon wallet can include the expiration date for each coupon as well as information about the time at which a certain coupon is commonly redeemed. For example, a user may be sent a reminder notification that a particular coupon offer is expiring soon. Alternatively, the user can be sent a reminder notification at a time prior to when a coupon is commonly redeemed. For example, a user can be sent a reminder notification at 11:30 am that they have a coupon for a sandwich shop such as Subway because sandwiches are commonly eaten for lunch.

The user can redeem 390 a coupon in a number of ways. For example, as described above, the coupon can be transmitted to a business device from a user's mobile device in any of the above described ways the two devices can be configured to communicate. Alternatively, a barcode associated with the coupon can be displayed on the user's mobile device and then scanned by the business device. In the case of a paper coupon, the scanned picture can be presented on the user device.

In some embodiments, upon redeeming 390 the coupon, the store can validate or verify the coupon as well as deem the coupon redeemed. The store can update this information on a verification server which can be in contact with the user's coupon wallet. Upon receiving information that the coupon has been redeemed, the coupon can be removed from the coupon wallet. Alternatively, if the store does not update this information, upon redeeming the coupon, the user can be prompted to have the coupon removed.

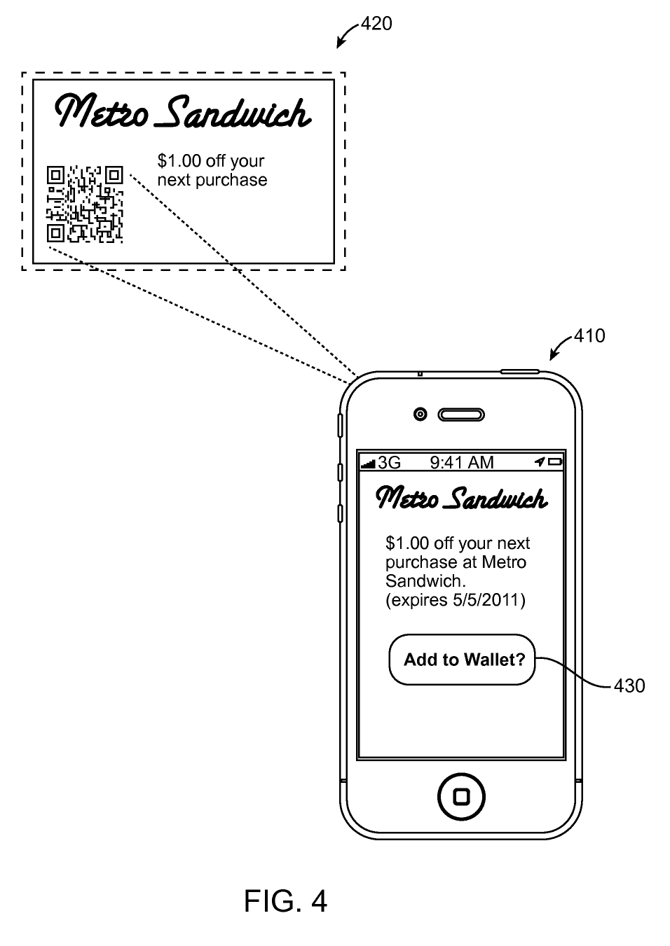

FIG. 4 illustrates one embodiment of a paper coupon being entered into the user's coupon wallet. As displayed, a coupon for Metro Sandwich 420 can include a bar code which may be scanned or be photographed by a user device 410. Upon being entered into the device, barcode information can be sent to a verification server to determine and verify the offer. The verification server can be the Metro Sandwich coupon-issuing server or another verification server where coupon information is stored. If the verification server returns information that the coupon is verified, the user may be prompted to add the coupon into the user's coupon wallet by, for example, pushing a button 430 on the mobile device 410.

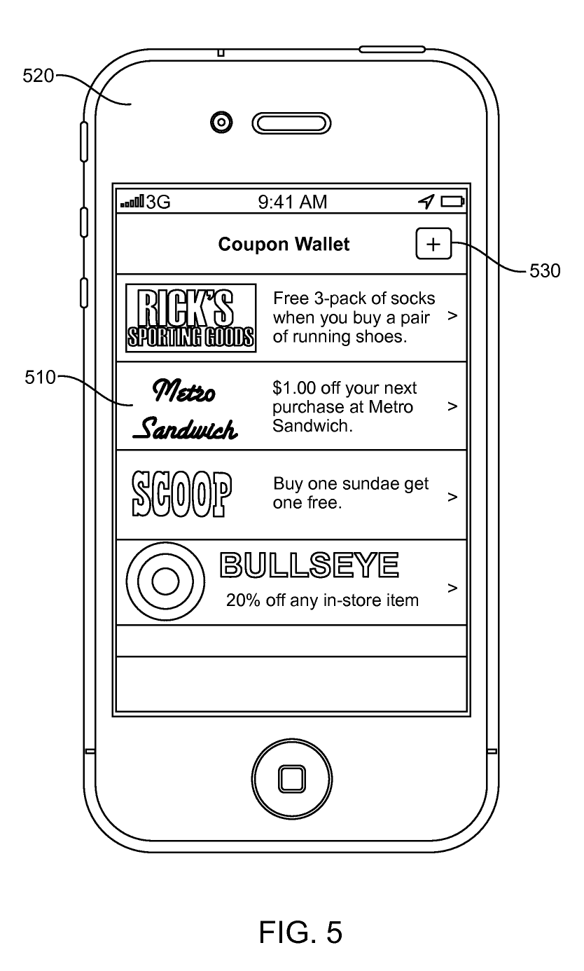

FIG. 5 illustrates a possible embodiment of what a user might be displayed upon entering a coupon into their coupon wallet. The mobile device 520 can display the contents of the user's coupon wallet. As illustrated, this can include the business the coupon may be redeemed at and details of the offer. Although not illustrated in this figure, other information can be displayed as well such as the coupon expiration date or locations at which the coupon can be redeemed. The metro sandwich coupon 510, which was added in FIG. 4, is listed. An add coupon button 530 can be displayed which a user can use to add additional coupons. As illustrated, the add coupon button 530 may be represented by a + sign to represent that it can be used to add coupons.

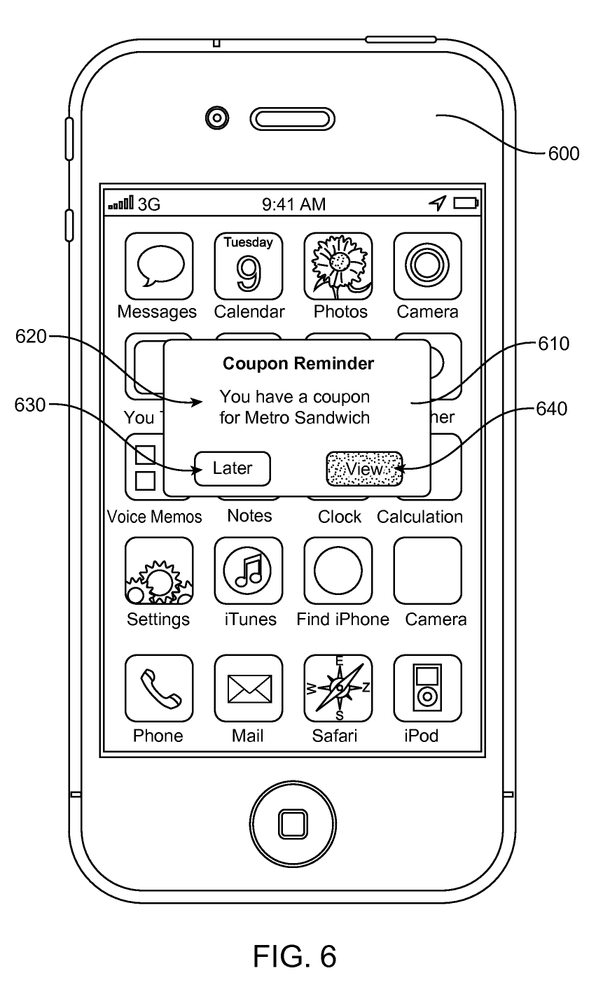

FIG. 6 illustrates a user receiving a coupon reminder on a mobile device 600. As illustrated, the user is being reminded that there is a coupon for Metro Sandwich in their coupon wallet. The coupon reminder, in this illustration, is a push notification. The reminder can come in numerous ways such as a text message or e-mail. The coupon reminder 610 can include a message 620 explaining the reminder. In this case, the user is told that “You have a coupon for Metro Sandwich.” As explained above, the coupon reminder could have been triggered in any number of ways, including the user entering a geo fence perimeter around a Metro Sandwich location. The coupon reminder 610 can also include buttons 630 and 640 allowing the user to view the details of the coupon 640 or dismiss the coupon to be viewed at a later date 630, however, the buttons can be configured to do any number of things such as redeem the coupon.

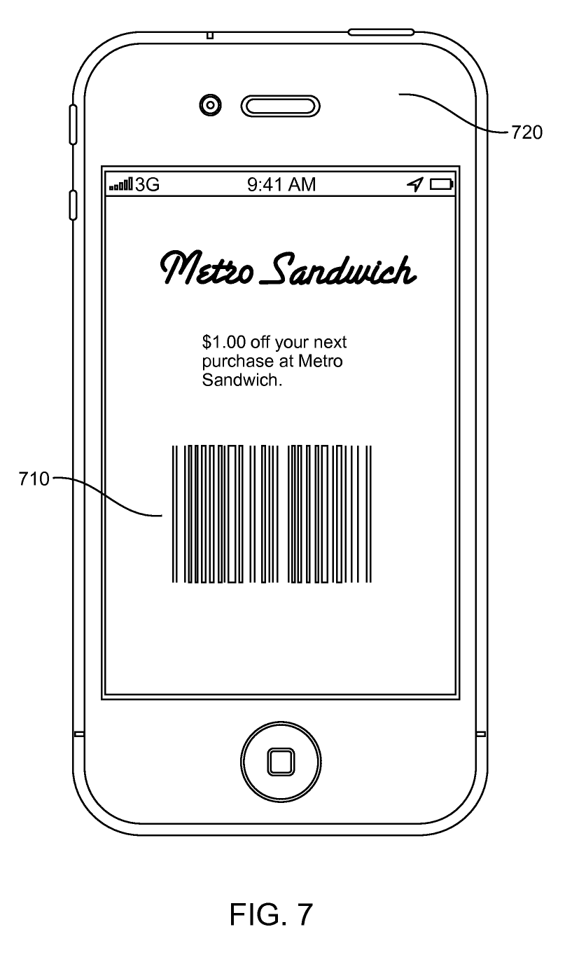

FIG. 7 illustrates an exemplary way in which a coupon stored in the user's coupon wallet can be redeemed. In this embodiment, the bar code 710 associated with the coupon is displayed on the mobile device 720. The user can present the bar code 710 at the time of purchase and the bar code 710 can be scanned by a business device. Coupon information can also be displayed. For example, in this embodiment the business name as well as details of the coupon are displayed, however, any information can be displayed including the coupon expiration date.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

I claim:

1. A computer-implemented method comprising:
storing a coupon in a coupon wallet associated with a user device;
detecting when the user device associated with the coupon wallet has entered an area proximate to a business at which the coupon is redeemable; and
presenting by the device, a notification relating to the coupon in response to the detection.

2. The computer-implemented method of claim 1, wherein the user device is determined to have entered the area proximate to the business when it receives a communication signal emitted from the business.

3. The computer-implemented method of claim 1, wherein the device is determined to have entered the area proximate to the business when the device is used in a sales transaction with the business.

4. The computer-implemented method of claim 3, further comprising:
receiving an itemized list of products or services to be purchased from a business device used in the sales transaction with the business.

5. The computer-implemented method of claim 3, further comprising:
automatically presenting the coupon referenced in the device notification to the sales transaction.

6. The computer-implemented method of claim 1, wherein the device is determined to have entered the area proximate to the business from a geopositioning determination feature on the device.

7. The computer-implemented method of claim 1, further comprising:
attempting to validate the coupon by transmitting coupon identifying information to a verification server; and
receiving a responsive communication validating the coupon.

8. The computer-implemented method of claim 1, wherein the coupon is associated with an expiration date, and the notification is presented in response to the coupon's impending expiration.

9. The computer-implemented method of claim 1, wherein information relating to the coupon is stored on the device.

10. The computer-implemented method of claim 1, wherein information relating to the coupon is stored on a server.

11. A system comprising:
a memory configured to store a coupon wallet for storing a coupon and associated with a mobile device;
a processor configured to detect when the user device associated with the coupon wallet has entered an area proximate to a business at which the coupon is redeemable; and
a display configured to present a notification relating to the coupon in response to the detection.

12. The system of claim 11 further comprising:
a mobile device having the memory, the processor and the display as its components.

13. The system of claim 11, further comprising:
a geolocation database in electronic communication with the processor configured to store location coordinates of business locations wherein the coupon is redeemable,
the processor being further configured to establish a geo-fence around a location coordinate of a business location where the coupon is redeemable, the location coordinate having been received from the geolocation database, whereby the processor detects when the user device associated with the coupon wallet has entered an area proximate to a business.

14. The system of claim 11, further comprising:
a business device configured to process a sales transaction and in electronic communication with the mobile device;
the processor being further configured to detect a product involved in the sales transaction on the business device for which a coupon is redeemable, whereby the processor detects when the user device associated with the coupon wallet has entered an area proximate to a business.

15. The system of claim 11, further comprising:
a coupon server configured to store information related to the coupon, and in electronic communication with the coupon wallet.

16. The system of claim 11, further comprising:
a verification server configured to store coupon validation information and redemption information, and in electronic communication with the coupon wallet to confirm the coupon's validity.

17. A non-transitory computer-readable storage medium storing instructions which, when executed by a computing device, cause the computing device to perform a method, the method comprising:
storing a coupon in a coupon wallet associated with a user device;
detecting when the user device associated with the coupon wallet has entered an area proximate to a business at which the coupon is redeemable; and
presenting by the device, a notification relating to the coupon in response to the detection.

18. The non-transitory computer-readable storage medium of claim 17, wherein the user device is determined to have entered the area proximate to the business when it receives a communication signal emitted from the business.

19. The non-transitory computer-readable storage medium of claim 17, wherein the device is determined to have entered the area proximate to the business when the device is used in a sales transaction with the business.

20. The non-transitory computer-readable storage medium of claim 19, further comprising:
receiving an itemized list of products or services to be purchased from a business device used in the sales transaction with the business.

21. The non-transitory computer-readable storage medium of claim 19, further comprising:
automatically presenting the coupon referenced in the device notification to the sales transaction.

22. The non-transitory computer-readable storage medium of claim 17, wherein the device is determined to have entered the area proximate to the business from a geopositioning determination feature on the device.

23. The non-transitory computer-readable storage medium of claim 17, further comprising:
attempting to validate the coupon by transmitting coupon identifying information to a verification server; and
receiving a responsive communication validating the coupon.

24. The non-transitory computer-readable storage medium of claim 17, wherein the coupon is associated with an expiration date, and the notification is presented in response to the coupon's impending expiration.

25. The non-transitory computer-readable storage medium of claim 17, wherein information relating to the coupon is stored on the device.

26. The non-transitory computer-readable storage medium of claim 17, wherein information relating to the coupon is stored on a server.
